(19) United States
(12) Patent Application Publication
(10) Pub. No.: US 2012/0039757 A1
(43) Pub. Date: Feb. 16, 2012

(54) FILTERING DEVICE FOR FOOD WASTE TREATMENT APPARATUS

(75) Inventors: Jun Young Yoo, Gyeonggi-do (KR); Chan Jung Park, Gyeonggi-do (KR)

(73) Assignee: WOONGJIN COWAY CO., LTD., Chungcheongnam-do (KR)

(21) Appl. No.: 13/262,517

(22) PCT Filed: May 12, 2009
(86) PCT No.: PCT/KR2009/002495

§ 371 Date: Sep. 30, 2011

(30) Foreign Application Priority Data
Apr. 3, 2009 (KR) 10-2009-0028961

(51) Int. Cl. B01D 53/34; B01D 53/04

(52) U.S. Cl. 422/168; 96/136; 96/132

(57) ABSTRACT

The present invention provides a filtering device for a food waste treatment apparatus. The filtering device includes a hygroscopic filter unit (240) which is connected to a drying furnace (202) of the food waste treatment apparatus and removes water from gas generated by the treatment of food waste, and a deodorization filter unit (230) which is connected to the hygroscopic filter unit to filter the gas supplied from the hygroscopic filter unit. The hygroscopic filter unit may be integrated with the deodorization filter unit. The present invention can remove water from gas generated from the food waste treatment apparatus and thus prevent pollution of the surroundings of the apparatus and corrosion of the apparatus. Furthermore, by the virtue of the dehumidifying function, the present invention can enhance the efficiency of a deodorization filter and reduce the frequency of replacement of the deodorization filter, thus reducing the maintenance cost.

### TECHNICAL FIELD

The present invention relates, in general, to food waste treatment apparatuses which treat food waste through drying and crushing operations and, more particularly, to a filtering device for a food waste treatment apparatus which includes a hygroscopic filter to remove water from gas generated by the food waste treatment apparatus and increase the efficiency of deodorization.

### BACKGROUND ART

Generally, a predetermined amount of food waste is discharged from each house or restaurant every day. Such food waste is directly used as stock feed, or it is discarded after only water is removed therefrom by a basic filtering net. However, this food waste treatment method increases the amount of waste and causes pollution in the surrounding air due to the generation of an odor if the food waste is not frequently discarded. To avoid the above problem, a food waste treatment apparatus is used.

Recently, efforts to reduce food waste in general houses and restaurants have increased, but there are many difficulties in reducing the amount of food waste as this has increased. Particularly, if food waste is embedded in the ground, environmental pollution is induced because of odors and food waste leachate as well as requiring facing the problem of the limited number or size of landfills available.

Thus, a waste fee system has been recently executed. The government of Korea stipulates that a food waste treatment apparatus using a fermentation method, a drying method or a dissolving method be installed in a group feeding institution or an apartment when it is newly constructed.

Typically, food waste contains about 80% to 90% water. Thus, to reduce of the amount of food waste, it is dried by heating and fermented by microbial reaction. However, when treating food waste, a large quantity of water and a severe odor are generated. Another treatment method is required to solve these problems.

Ordinarily, odor generated from a food waste apparatus results from the composition of several kinds of gases which are generated when treating food waste. Depending on conditions of the food waste, for example, the kind of food waste, the time passed since the food waste was discarded, a treatment temperature, etc., the constituents of the gas vary. In the case where decay or abnormal fermentation, that is, anaerobic fermentation, is induced, a lot of toxic gas which has an offensive odor and may be harmful to the human body is generated.

Furthermore, during a continuous food waste treatment process, anaerobic conditions are partially formed. Thus, as the food waste treatment proceeds, the intensity of the odor is further increased. Here, gases which are the cause of odor are classified into an acid gas, a neutral gas and an alkaline gas. Sulfurated hydrogen, methyl mercaptan, etc., are representative examples of the acid gas. Examples of the alkaline gas are ammonia, trimethylamine, etc. Methyl sulfide, methyl disulfide, acetaldehyde, etc., are representative examples of the neutral gas.

Such an odorous gas is harmful to the human body, pollutes the environment, and disgusts surrounding people.

Furthermore, if food waste containing a large quantity of water is left, it easily decays and generates an odor, thus deteriorating the sanitation of the surroundings. Hitherto, many companies have tried to develop techniques to solve above problems. Various food waste treatment products used in houses and restaurants have been proposed, for example, using a hot-air drying method, a hot-air drying method including an agitating function, a hot-air drying method including an agitating function and a crushing function, a method using an agitating function and microbial treatment together, a refrigeration method, etc.

As such, hitherto, various methods and products have been proposed to remove water from food waste. However, a method for removing water from gas generated in a food waste treatment apparatus has been seldom considered.

FIG. 1 is a view showing the construction of a conventional filtering device 120 for a food waste treatment apparatus. As shown in FIG. 1, the food waste treatment apparatus includes an apparatus main body 100 which crushes and dries food which was input thereinto through a hopper 105, and the filtering device 120 which removes the odor of a gas generated from the apparatus main body 100. The filtering device 120 includes a filter unit 130 which receives gas from the apparatus main body 100 through an inlet 131 connected to a gas flow pipe 115 and purifies the gas, and a purified air discharge port 170 which discharges the purified gas from the filter unit 130 through a connection pipe 150 coupled to an outlet 133 of the filter unit 130. Typically, the filter unit 130 uses a catalyst filter or an activated filter. A heat insulation shell 160 may surround the filter unit 130.

However, if the conventional filtering device 120 filters gas containing a large quantity of water, water is collected in a deodorization filter, thus reducing the lifetime of the filter, and reducing the deodorization efficiency of the filter. Furthermore, because the conventional technique cannot satisfactorily remove water generated from the food waste treatment apparatus, food waste easily decays, with the result that it is insanitary and the apparatus may corrode.

### DISCLOSURE OF INVENTION

### Technical Problem

Accordingly, the present invention has been made keeping in mind the above problems occurring in the prior art, and an object of the present invention is to provide a filtering device for a food waste treatment apparatus which includes a hygroscopic filter to remove water generated from the food waste treatment apparatus, thus increasing efficiency of the deodorization.

### Technical Solution

In order to accomplish the above object, the present invention provides a filtering device for a food waste treatment apparatus, including: a hygroscopic filter unit connected to a drying furnace of the food waste treatment apparatus to remove water from gas generated when the food waste treatment apparatus crushes and dries food waste; and a deodorization filter unit connected to the hygroscopic filter unit to filter the dehumidified gas supplied from the hygroscopic filter unit. The hygroscopic filter unit may be integrated with the deodorization filter unit.

Preferably, the deodorization filter unit may include: a hollow inner housing supporting therein a hollow deodorization filter casing containing the deodorization filter therein; a hollow outer housing supporting the hollow inner housing therein; and an upper cover covering an upper end of the inner housing, the upper cover being partially open. The hygroscopic filter unit may include: a hygroscopic filter connected to the lower end of the outer housing of the deodorization filter unit to remove water from the gas supplied from the deodorization filter unit; and a hygroscopic filter casing containing the hygroscopic filter therein.

The deodorization filter may comprise one of an activated carbon filter and a catalyst filter.

The catalyst filter may comprise a high-temperature catalyst cartridge using one of platinum, palladium, rhodium, manganese, copper and zinc as a catalyst, or a low-temperature catalyst cartridge using pellet-shaped or granular activated carbon coated with a catalyst.

Furthermore, a heat insulation shell may surround the outer surface of the deodorization filter unit.

The hygroscopic filter may further comprise one of nylon, non woven fabric, zeolite and SAP (super absorbent polymer).

The SAP may comprise SAP powder having particles ranging in diameter from 0.1 mm to 0.3 mm.

The hygroscopic filter casing may be made of paper or cellulose.

### Advantageous Effects

As described above, a filtering device for a food waste treatment apparatus according to the present invention can remove water generated from the food waste treatment apparatus and thus prevent pollution of the surroundings of the apparatus and prevent the apparatus from being damaged due to corrosion. Furthermore, by virtue of the dehumidifying function, the present invention can enhance the efficiency of a deodorization filter and reduce the frequency of replacement of the deodorization filter, thus reducing the maintenance cost.

### BRIEF DESCRIPTION OF DRAWINGS

FIG. 1 is a view showing the construction of a conventional filtering device for a food waste treatment apparatus;

FIG. 2 is a schematic view showing the operation of a food waste treatment apparatus having a filtering device according to an embodiment of the present invention;

FIG. 3 is a perspective view of the filtering device of FIGS. 2; and

FIG. 4 is an exploded perspective view of the filtering device of FIG. 3.

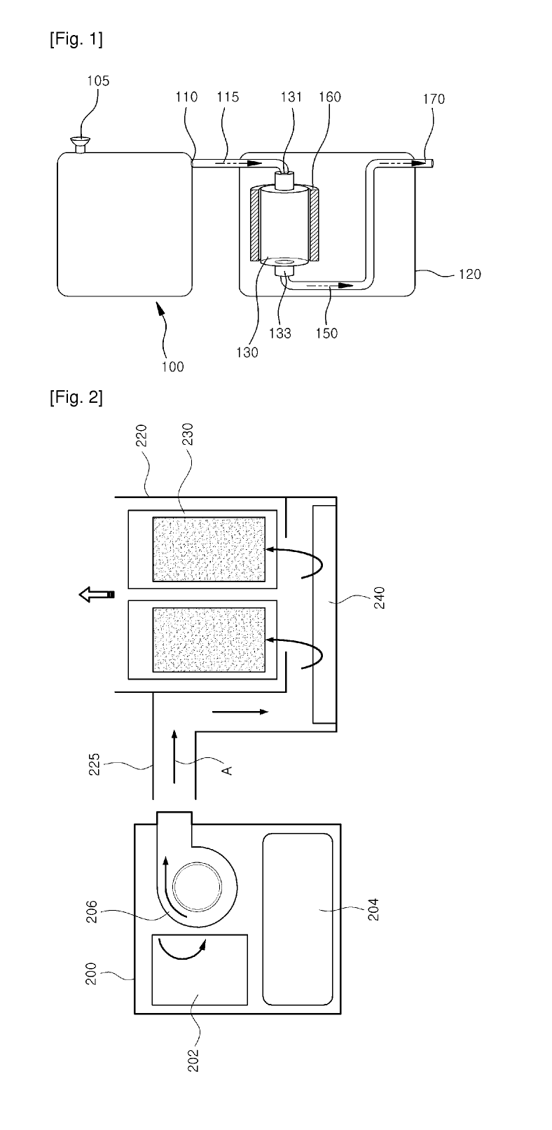

### BEST MODE FOR CARRYING OUT THE INVENTION

The above and other objects, features and advantages of the present invention will be more clearly understood from the following detailed description taken in conjunction with the accompanying drawings. Hereinafter, a filtering device for a food waste treatment apparatus according to an embodiment of the present invention will be described in detail with reference to the attached drawings.

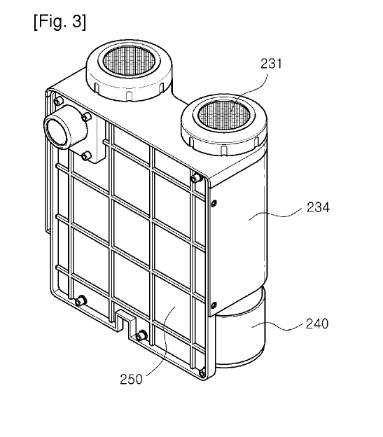

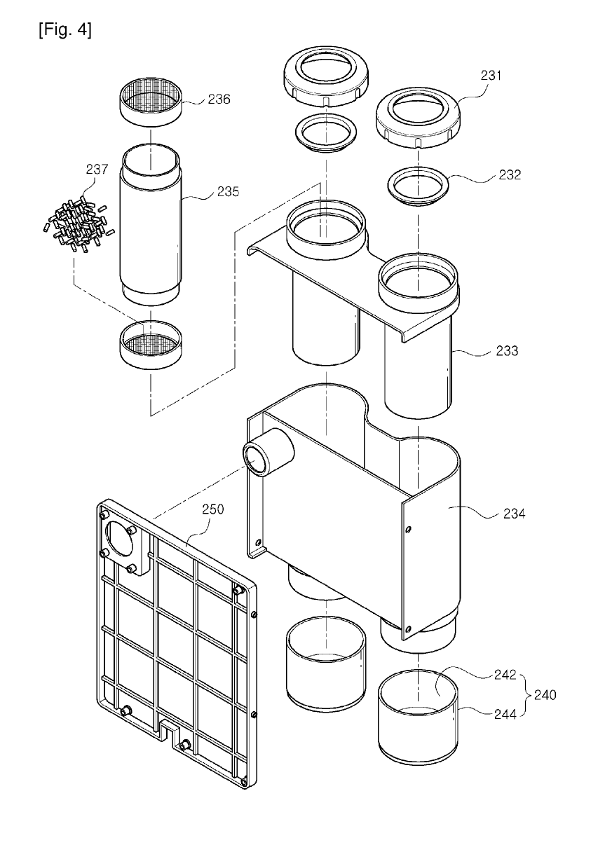

FIG. 2 is a schematic view showing the operation of the food waste treatment apparatus having the filtering device according to the embodiment of the present invention. FIG. 3 is a perspective view of the filtering device of FIG. 2. FIG. 4 is an exploded perspective view of the filtering device of FIG. 3.

As shown in FIG. 2, the food waste treatment apparatus according to the present invention includes an apparatus main body 200 which crushes and dries food which was input thereinto through a hopper, and the filtering device 220 which removes the odors from a gas generated from the apparatus main body 200 and eliminates water contained in the gas.

Furthermore, the apparatus main body 200 has therein a drying furnace 202 which dries and crushes food waste, a recovery box 204 which carries food waste treated by the drying furnace 202 out, and a fan 206 which rotates to discharge gas from the drying furnace 202 to the outside. The filtering device 220 is disposed beside the apparatus main body 200 and connected to the apparatus main body 200 through a gas flow pipe 225. The filtering device 220 includes a hygroscopic filter unit 240 which eliminates water contained in gas generated from the apparatus main body 200, and a deodorization filter unit 230 which removes odors from the gas dehumidified by the hygroscopic filter unit 240.

The hygroscopic filter unit 240 and the deodorization filter unit 230 are connected to each other in series or in parallel in the filtering device 220. It is preferable that gas drawn from the apparatus main body 220 be first dehumidified by passing through the hygroscopic filter unit 240. The reason for this is that the efficiency of the deodorization filter can be enhanced by removing water from the gas before.

The operation of the food waste treatment apparatus according to the present invention will be explained with reference to FIG. 2.

When a user opens an opening formed in the apparatus main body 200 and puts food waste into the drying furnace 202, the food waste in the drying furnace 202 is treated by heat supplied from the outside and by the operation of a crusher. The dried and crushed food waste is put into the recovery box 204 and carried out to the outside by the user. Odorous gas generated when the food waste is heated and crushed in the drying furnace 202 is discharged to outside the apparatus main body 200 through the gas flow pipe 225 by the operation of the fan 206 provided at a predetermined position in the apparatus main body 200.

Here, the gas flowing through the gas flow pipe 225 may be directly discharged to the atmosphere, but this may cause air pollution. To prevent this, the present invention is configured to conduct the filtering process before gas is discharged to the atmosphere.

With regard to odors generated from food waste, several kinds of gases are generated when treating food waste. Depending on the conditions of the food waste, for example, the kind of food waste, the time passed since the food waste was discarded, a treatment temperature, etc., the constituents of the gas vary. In the case where decay or abnormal fermentation, that is, anaerobic fermentation, is induced, a lot of toxic gas which has an offensive odor and which may be harmful to the human body is generated.

Furthermore, during a continuous food waste treatment process, anaerobic conditions are partially formed. As the food waste treatment proceeds, the intensity of the odors is further increased. Here, gas which is the cause of the odor is classified into an acid gas, a neutral gas and an alkaline gas. Sulfurated hydrogen, methyl mercaptan, etc., are representative examples of the acid gas. Examples of the alkaline gas are ammonia, trimethylamine, etc. Methyl sulfide, methyl disulfide, acetaldehyde, etc., are representative examples of the neutral gas.

Such odorous gas is harmful to the human body, pollutes the environment, and disgusts surrounding people. To solve these problems, the food waste apparatus of the present invention includes the filtering device 220 for dehumidification and deodorization.

Referring to FIG. 2, odor gas which has passed through the gas flow pipe 225 is drawn into the filtering device 220 (as shown by the arrow of A).

In the filtering device 220, the odorous gas is dehumidified by passing through the hygroscopic filter unit 240, and the dehumidified gas is deodorized by passing through the deodorization filter unit 230 and then is discharged to air.

Here, the hygroscopic filter unit 240 and the deodorization filter unit 230 can be connected to each other in series or in parallel, and the number of them may be varied as necessary.

The filtering device 220 of the present invention will be explained in more detail with reference to FIGS. 3 and 4.

The filtering device 220 includes the deodorization filter unit 230 and the hygroscopic filter unit 240. The deodorization filter unit 230 has a hollow inner housing 233, into which a hollow deodorization filter casing 235 containing a deodorization filter 237 therein is installed, a hollow outer housing 234 which supports the hollow inner housing 233 therein, and an upper cover 231 which covers the upper end of the hollow inner housing 233 and is partially open. The hygroscopic filter unit 240 has a hygroscopic filter 242 which is coupled to the lower end of the outer housing 234 to remove water from the gas, and a hygroscopic filter casing 244 which contains the hygroscopic filter 242 therein.

Furthermore, a heat insulation shell (not shown) may be provided on the outer surface of the deodorization filter unit 230 to prevent high heat from being emitted to the outside. Thereby, the heat efficiency of the food waste treatment apparatus can be increased, and the internal elements of the apparatus can be prevented from being damaged.

In addition, a mounting bracket 250 is provided on the filtering device 220, so that it can be easily fastened to the apparatus main body 200 through the mounting bracket 250.

An O-ring 232 is further interposed between the upper cover 231 and the hollow inner housing 233 to prevent substances in the hollow inner housing 233 from leaking.

The deodorization filter casing 235 has a hollow cylindrical shape and contains the deodorization filter 237 therein. Mesh covers 236 are respectively fitted over the upper and lower ends of the deodorization filter casing 235, thus allowing gas to pass through the deodorization filter casing 235 while keeping the deodorization filter 237 in the deodorization filter casing 235.

Of course, in place of the mesh covers 236, other kinds of porous covers may be coupled to the upper and lower ends of the deodorization filter casing 235, so long as they can conduct the intended purposes.

One of an activated carbon filter and a catalyst filter may be used as the deodorization filter 237. Typically, activated carbon provided in the activated carbon filter means charcoal. The activated carbon has superior adsorptivity and hygroscopicity. Furthermore, because a lot of fine pores are formed in the activated carbon, harmful gas is filtered by the fine pores when passing through the activated carbon filter. Particularly, special activated carbon that is processed into a fiber shape to improve the adsorptivity thereof is called ACF (activated carbon fiber). With regard to the adsorption of the activated carbon, substances to be adsorbed are moved by diffusion into macropores formed in the surface of the activated carbon, and are adsorbed by mesopores formed inside the macropores. However, the case of the ACF has mesopores in the surface thereof without having macropores. Hence, the ACF exhibits markedly rapid adsorption, because the diffusion process of substances to be adsorbed is not required.

The characteristics of activated carbon are determined by the shapes and the surface area of pores. Typically, the overall surface area of pores of the activated carbon is 700 to 17000 times larger than the area of activated carbon.

In the case of the activated carbon, the ability to remove agricultural chemicals, synthetic detergents and odors is very superior, but as the amount of substances adsorbed by the activated carbon increases, the adsorption efficiency thereof deteriorates so that its replacement or regeneration is required. If the activated carbon is shaken or air flows backwards, substances that have been adsorbed thereto may be undesirably discharged.

Furthermore, the adsorption amount of the activated carbon filter varies depending on the density of harmful gas. This can be controlled depending on the pore size distribution of the activated carbon or the impregnated materials.

Meanwhile, a catalyst cartridge is installed in the catalyst filter. Preferably, a high-temperature catalyst cartridge or a low-temperature catalyst cartridge is used as the catalyst cartridge.

The high-temperature catalyst cartridge can remove volatile organic compounds

(VOC) using a catalyst, such as platinum, palladium, rhodium, manganese, copper, zinc, etc. The low-temperature catalyst cartridge can remove gases, such as trimethylamine, acetaldehyde, methyl sulfide, etc., using pellet-shaped or granular activated carbon coated with a catalyst.

The hygroscopic filter casing 244 has a hollow shape and is made of paper or cellulose. Furthermore, the hygroscopic filter casing 244 functions to stably support the hygroscopic filter 242 therein.

The hygroscopic filter 242 is made of one of nylon, non woven fabric, zeolite, and

SAP (super absorbent polymer).

The SAP is a high molecular weight polymer in which a bridge bond or insoluble part is applied to a polyelectrolyte. A powdered or fabric-shaped block copolymer of acrylic acid and vinyl alcohol is used as the SAP. Typically, absorbent cotton or cotton cloth absorbs water using capillary action between fibers but easily discharges water when it is compressed. The SAP absorbs a large amount of water and does not easily discharge water even though it is compressed.

Zeolite has a crystal structure in which bonding between atoms is relatively loose. Thus, even though water that has been charged therebetween is discharged by high heat, the framework can be maintained in the original state, so that minute particles can be easily adsorbed thereto.

As such, gas generated from the apparatus main body 200 is dehumidified by the hygroscopic filter 242. Thereby, the humidity of gas drawn into the deodorization filter 237 decreases. Hence, the deodorization efficiency of the deodorization filter 237 can be enhanced.

In the filtering device of the food waste treatment apparatus according to the conventional technique, odorous gas is directly filtered by the deodorization filter. However, in the case of odorous gas containing a large quantity of water, the deodorization efficiency of the deodorization filter is reduced. In addition, the deodorization filter cannot be used for a long period of time, in other words, it must be frequently replaced with a new one, with the result that the replacement cost is increased.

Unlike the conventional technique, in the present invention, the filtering device 220 has the hygroscopic filter unit 240. Thus, odorous gas generated from the apparatus main body 200 is dehumidified by the hygroscopic filter unit 240, before the dehumidified gas is deodorized by the deodorization filter unit 230. Thereby, the deodorization efficiency can be enhanced, and the maintenance cost can be reduced.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A filtering device for a food waste treatment apparatus, comprising:
a hygroscopic filter unit to receive gas generated when treating food waste and remove water from the gas; and
a deodorization filter unit connected to the hygroscopic filter unit to receive and filter the gas supplied from the hygroscopic filter unit,
wherein the hygroscopic filter unit comprises a hygroscopic filter, and the deodorization filter unit comprises a deodorization filter,
the hygroscopic filter comprises SAP (super absorbent polymer), and the SAP comprises SAP powders having diameters ranging from 0.1 mm to 0.3 mm to reduce water contained in the gas passing through the SAP which blocks pores of the deodorization filter.

2. The filtering device according to claim 1, wherein the hygroscopic filter unit is connected to the deodorization filter unit through a first connection pipe.

3. The filtering device according to claim 1 or 2, wherein the deodorization filter unit comprises a first deodorization filter unit and a second deodorization filter unit.

4. The filtering device according to claim 3, wherein the first deodorization filter unit is connected to the second deodorization filter unit through a second connection pipe.

5. The filtering device according to claim 3, wherein the first deodorization filter unit and the second deodorization filter unit are integrated with each other.

6. The filtering device according to claim 1 or 2, wherein
the deodorization filter unit further comprises: a hollow inner housing supporting therein a hollow deodorization filter casing containing the deodorization filter therein; a hollow outer housing supporting the hollow inner housing therein; and
an upper cover covering an upper end of the inner housing, the upper cover being partially open,
the hygroscopic filter unit further comprises a hygroscopic filter casing which is connected to a lower end of the outer housing and contains the hygroscopic filter therein.

7. The filtering device according to claim 1 or 2, wherein the deodorization filter comprises one of an activated carbon filter and a catalyst filter.

8. The filtering device according to claim 7, wherein the catalyst filter comprises a high-temperature catalyst cartridge using one of platinum, palladium, rhodium, manganese, copper and zinc as a catalyst, or a low-temperature catalyst cartridge using pellet-shaped or granular activated carbon coated with a catalyst.

9. The filtering device according to claim 1 or 2, wherein the hygroscopic filter further comprises one of nylon, non woven fabric and zeolite.

10. The filtering device according to claim 6, wherein the hygroscopic filter casing is made of paper or cellulose.

11. A hygroscopic filter comprising SAP,
wherein the SAP comprises SAP powder having particles ranging in diameter from 0.1 mm to 0.3 mm to reduce a water content of gas passing through the SAP.

12. The hygroscopic filter according to claim 11, further comprising:
one of nylon, non woven fabric and zeolite.
